(19) United States
(12) Patent Application Publication
(10) Pub. No.: US 2015/0346148 A1
(43) Pub. Date: Dec. 3, 2015

(54) Method and Apparatus for Manipulating Samples Using Optoelectronic Forces

(71) Applicants: Agilent Technologies, Inc., Loveland, CO (US); Agilent Technologies, Inc., Loveland, CO (US)

(72) Inventors: Curt A. Flory, Los Altos, CA (US); Arthur Schleifer, Portola Valley, CA (US)

(73) Assignee: Agilent Technologies, Inc., Loveland, CO (US)

(21) Appl. No.: 14/289,405

(22) Filed: May 28, 2014

(51) Int. Cl. G01N 27/447

(52) U.S. Cl. CPC G01N 27/44756

(57) ABSTRACT

An apparatus for controlling the motion of a particle and a method for using the same are disclosed. The apparatus includes a channel containing liquid between first and second electrodes. The apparatus also includes an array of variable impedance elements, each variable impedance element connecting the first electrode to a corresponding location in the channel by a path having an average impedance that is continuously variable between first and second impedances when averaged over an update time interval. A controller sets the average impedance of each of the variable impedance elements such that a particle in the channel moves in a predetermined direction when voltage is applied between the first and second electrodes. At least one of the variable impedance elements has an average impedance that is intermediate between the first and second impedances.

### BACKGROUND OF THE INVENTION

Manipulation of micrometer-scale particles is of central importance in cell biology and microfluidics. The particles can be cells or components thereof that are to be studied or small droplets containing such components. For example, individual cells can be isolated in small aquaise droplets that move in a hydrophobic medium. The cells can be moved to locations in which the cellular contents are measured. The cells can also be lysed and the cellular contents studied within the droplet that now contains the cellular contents. Ideally, thousands of such droplets can be processed in parallel by using electrical forces to move the individual droplets or particles within an apparatus.

To simplify the following discussion, the object that is being moved will be referred to as a “particle” unless the context indicates otherwise. The particle could be a small droplet containing something of interest that is to be studied. In other cases, the particle could be a cell or other object that is to be studied as opposed to a droplet containing the cell.

Optical tweezers and dielectrophoretic (DEP)-based devices have been used to actuate particle motion. In particular, optoelectronic tweezers (OETs) have emerged as useful tools in moving biological samples, as the environment of the sample can be maintained within physiological acceptable limits that do not compromise the sample being studied. In a prior art OET device, an electric field is created in the vicinity of the particle being manipulated. The particle is typically confined between two parallel surfaces. The electric field has a component that is parallel to these surfaces and a component that is perpendicular to these surfaces. Motion of a particle parallel to one of these surfaces will be referred to as lateral motion in the following discussion, and motion of a particle perpendicular to these surfaces will be referred to as vertical motion.

The dielectric nature of the particle causes the particle to move in the direction of the gradient of the electric field strength. The field typically creates a potential well as a function of lateral position. The particle moves to the minimum energy point in the well. Hence, to move a particle from its current location to the next desired location, the field is altered such that the minimum of the potential well is moved to a location that is adjacent to the current location. The particle then experiences a lateral dielectrophoretic force that causes the particle to move to the new location. The particle also experiences a vertical dielectrophoretic force that causes the particle to move toward one of the surfaces.

Prior art OET devices have a limited ability to control the shape of the electric field in the vicinity of the particle. As a result, the magnitude of the lateral component of the dielectrophoretic force that is used to move a particle varies significantly with the vertical position of the particle relative to the parallel surfaces. The control system must wait until a particle that is being moved has had time to move to the current well location before altering the location of the potential well. As a result, the maximum rate at which a particle is moved along a desired path is limited to the rate of motion at the locations corresponding to the weakest lateral dielectrophoretic force component.

### SUMMARY OF THE INVENTION

The present invention includes an apparatus for controlling the motion of a particle and a method for using the same. The apparatus includes a channel containing liquid between first and second electrodes. The apparatus also includes an array of variable impedance elements, each variable impedance element connecting the first electrode to a corresponding location in the channel by a path having an average impedance that is continuously variable between first and second impedances when averaged over an update time interval. A controller sets the average impedance of each of the variable impedance elements such that a particle in the channel moves in a predetermined direction when voltage is applied between the first and second electrodes. At least one of the variable impedance elements has an average impedance that is intermediate between the first and second impedances.

In one aspect of the invention, each of the variable impedance elements includes a switchable photoconductive element having an impedance equal to the first impedance if the switchable photoconductive element is not illuminated with light and an impedance equal to the second impedance if the switchable photoconductive element is illuminated with light. The apparatus also includes an optical display that projects an image onto the array of variable impedance elements. In one embodiment, the switchable photoconductive elements include a layer of photoconductive material that connects the channel to the first electrode. In another embodiment, the switchable photoconductive elements comprise a phototransistor.

In another aspect of the invention, the controller sets the average impedance of a first one of the variable impedance elements to a first value and sets the average impedance of a second one of the variable impedance elements to a second value. The first one of the variable impedance elements is adjacent to the second one of the variable impedance elements, and the first value is different from the second value. In one embodiment, both the first and second values are intermediate between the first and second impedances.

In yet another aspect of the invention, one of the variable impedance elements has an impedance equal to the first impedance during a first part of the update time interval and an impedance equal to the second impedance during a second part of the update time interval, the first part and the second part are set to provide the average impedance.

### BRIEF DESCRIPTION OF THE DRAWINGS

FIG. 1 illustrates the manner in which a prior art OET device generates an electric field that is used to manipulate a particle.

FIG. 2 illustrates the potential difference between surface 18 and the second electrode as a function of lateral position in a region around a spot that is illuminated.

FIG. 3 illustrates such a continuously varying potential.

FIG. 4 is a schematic illustration of an OET device that utilizes phototransistors in place of the photoconductive layer described above.

FIG. 5 illustrates an embodiment of a particle manipulation device according to one embodiment of the present invention.

FIGS. 6A and 6B illustrate the operation of a micro-mirror device.

FIG. 7 illustrates a particle manipulation device according to an embodiment of the present invention that utilizes an LCD display.

FIG. 8 illustrates a particle motion device according to another embodiment of the present invention in which a direct contact display arrangement is utilized.

### DETAILED DESCRIPTION

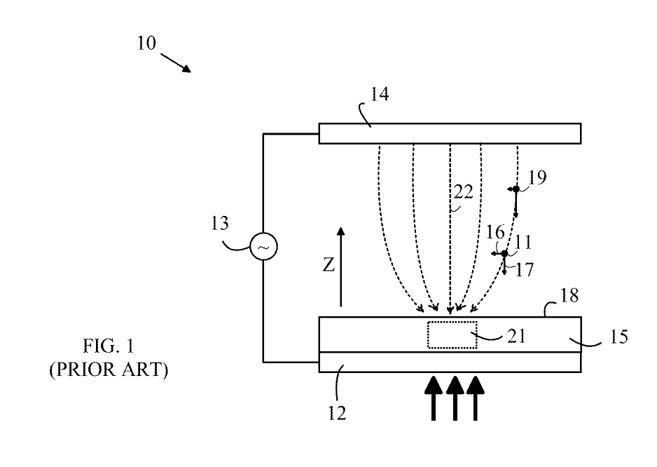

The manner in which the present invention provides its advantages can be more easily understood with reference to FIG. 1, which illustrates the manner in which a prior art OET device generates an electric field that is used to manipulate a particle. OET device 10 includes a first electrode 12 and a second electrode 14 having a potential applied therebetween by AC source 13. Electrode 12 is a transparent electrode. In some embodiments, electrode 14 is also a transparent electrode to allow the contents of the channel between the electrodes to be viewed using a suitable optical system. The channel can be a two-dimensional channel or a one-dimensional channel.

A photoconductive layer 15 is placed adjacent to first electrode 12 and prevents the applied voltage between electrodes 12 and 14 from reaching surface 18 of photoconductive layer 15. At locations that are illuminated such as location 21, surface 18 is connected to electrode 12 and becomes a counter electrode to second electrode 14. The resulting electric field lines are shown at 19. A particle 11 that is suspended between first electrode 12 and second electrode 14 experiences a force that is directed along the gradient of the electric field strength at that location. That force has a lateral component 16 and a vertical component 17. Lateral component 16 causes particle 11 to move until particle 11 is at field line 22. The magnitude of the lateral component depends on the distance, Z, of the particle from surface 18. Particles that are closer to surface 18 experience a significantly higher lateral field component than particles that are closer to second electrode 14. Hence, a particle that is closer to second electrode 14 takes longer to reach a location on field line 22 than one that is closer to surface 18.

The use of an AC source ensures that charged particles will not have a net movement toward one of the electrodes, since the vertical forces on the particle reverse with each cycle of the AC source 13, and hence, the vertical location of the particle oscillates about some equilibrium location.

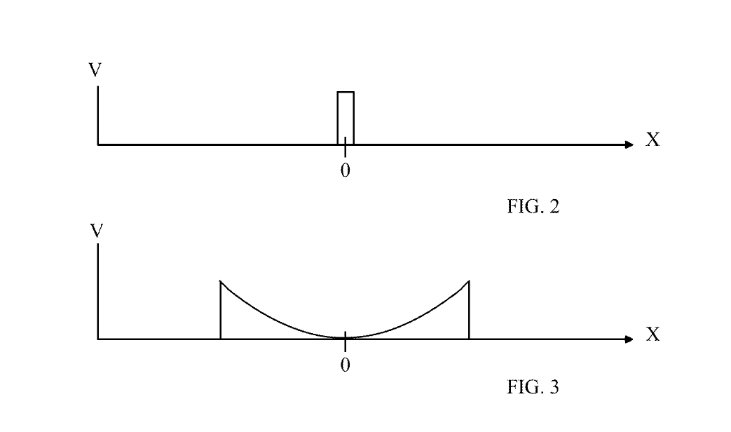

At any given time, there is some potential difference between the first and second electrodes and that potential difference appears across the space between the two plates at those locations at which the photoconducting layer is illuminated. Refer now to FIG. 2, which illustrates the potential difference between surface 18 and the second electrode as a function of lateral position in a region around a spot that is illuminated. To simplify the discussion, the lateral position of the center of the spot is chosen to be at x=0. This is also the equilibrium location to which a particle that is within the field generated by this potential will move. It should be noted that while the size of the conducting spot on surface 18 can be changed, the voltage within the conducting spot remains constant as a function of position in the spot. This constraint results in the undesirable variation in the lateral dielectrophoretic force discussed above.

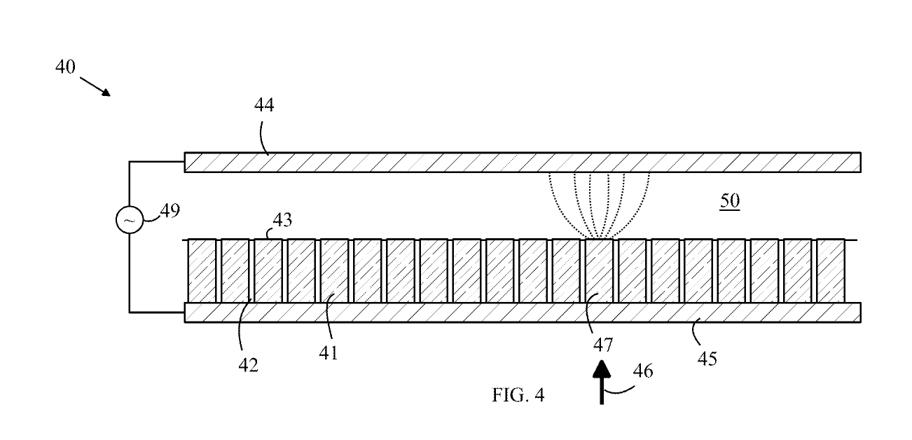

The present invention is based on the observation that the electric field shape could be altered to provide a relatively larger lateral dielectric force and a relatively smaller vertical dielectrophoretic force if the potential as a function of lateral position on surface 18 could be varied. Refer now to FIG. 3, which illustrates such a continuously varying potential. In the example shown in FIG. 3, the potential difference satisfies the relationship:

V(x)=x² for x=[−10,10] and

V(x)=0 otherwise (1)

Here, x=0 is also the desired position of the particle after the particle moves. It can be shown that the lateral dielectrophoretic force can be made substantially larger than the vertical dielectrophoretic force for the voltage distribution of FIG. 3, whereas the reverse is true for the voltage distribution of FIG. 2.

The manner in which this type of voltage pattern can be generated on the surface of the channel through which the particles move can be more easily understood with reference to FIG. 4, which is a schematic illustration of an OET device that utilizes phototransistors in place of the photoconductive layer described above. In OET device 40, the layer of photoconductive material discussed above with respect to OET device 10 is replaced by an array of phototransistors that are surrounded by insulating regions. A typical phototransistor is labeled at 41, and a typical surrounding insulating region is labeled at 42. The top surface of each of the phototransistors is connected to a conducting pad such as pad 43. When a particular phototransistor, such as phototransistor 47, is illumined with a light beam 46, the pad connected to that phototransistor is connected to electrode 45. The array of phototransistors is preferred in OET devices in which the medium in channel 50 has a high conductivity. In such cases, the impedance between the channel and electrode 45 needs to be less than the impedance between electrode 44 and pad 43 when phototransistor 47 is illuminated. The phototransistors provide a larger impedance variation than the photoconductive layer such as that described with reference to FIG. 1.

To achieve the voltage patterns shown in Eq. (1), a potential other than that achieved by switching a pad between two fixed voltages is required. That is, the particle must experience an electric field that would be created by an “analog” potential on the pads in the vicinity of the particle. Since adjacent pads need to have different potentials, the potential cannot be generated merely by changing the amplitude of the signal from voltage source 49.

To simplify the following discussion, denote the peak potential on the pads when a phototransistor is fully conducting by Vₘₐₓ and the potential on the pads when the phototransistor is non-conducting by Vₘᵢₙ. As noted above, the applied potentials are typically AC signals, and hence, Vₘᵢₙ and Vₘₐₓ refer to the maximum amplitude of the AC signal. To achieve the desired potential pattern, each pad in the vicinity of a particle must exhibit an AC potential that has an amplitude between Vₘₐₓ and Vₘᵢₙ. Such a potential will be referred to as an “intermediate” potential in the following discussion. If a DC potential is applied, the DC potential has an average potential between Vₘₐₓ and Vₘᵢₙ. To simplify the following discussion, Vₘₐₓ and Vₘᵢₙ will be used to denote the maximum and minimum amplitudes of the AC voltage, respectively, when an AC signal is used unless the context indicates otherwise.

A particle is moved within channel 50 by setting a potential pattern and waiting for a time that will be referred to as the “update time interval”. The update time interval is chosen to be sufficient for the particles to move to a new location at which a different potential pattern is needed to continue the motion of the particle in the desired direction. At the end of the update time interval, the potential pattern is updated to reflect the new position of the particle and the dielectrophoretic force needed to continue the particle's motion in the desired direction. Update times intervals are typically of the order of 100 msec to 1 second. In the prior art systems, the potential pattern is held constant for the entire update time interval, and each pad has an AC voltage that has a maximum amplitude equal to either Vₘₐₓ or Vₘᵢₙ.

In one aspect of the present invention, the slow response of the particle to a change in potential on a pad is utilized to achieve the desired potential pattern. As will be explained in more detail below, the time needed to change a potential pattern is of the order of 10 microseconds. Consider a case in which the potential on a pad is turned on and off repeatedly during the update time interval. The potential on a pad can be turned on and off much faster than a particle can respond to the change. In effect, the particle averages the changes in potential. As a result, the particle experiences an intermediate effective potential whose magnitude is determined by the fraction of the update time interval the pad is at Vₘₐₓ. The fraction of the time in which the pad is at Vₘₐₓ will be referred to as the duty factor in the following discussion. The average potential is proportional to the duty factor. In one embodiment, the duty factor is achieved by using a sequence of high frequency pulses having the desired duty factor. In another embodiment, the duty factor is achieved by applying Vₘₐₓ to the pad for a fixed period of time and then applying Vₘᵢₙ for the remainder of the update time interval. It should be noted that the duty factor will, in general, vary for different pads in the vicinity of the particle, so that not all pads have the same duty factor.

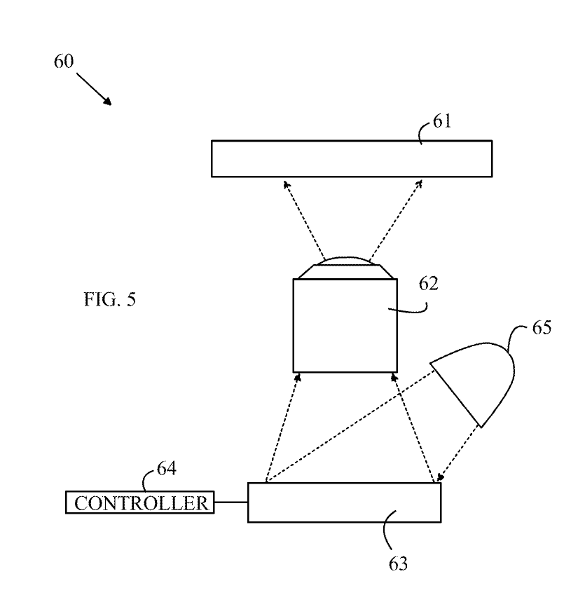

In the above-described embodiments, the potential on each pad is controlled by illuminating the pad with a light source. In general, there are large numbers of particles that are being manipulated in parallel. In one aspect of the invention, the OET device is controlled by projecting an “image” onto the first electrode, which is a transparent electrode. Transparent electrodes are known to one skilled in the art, and hence, will not be discussed in detail here. Refer now to FIG. 5, which illustrates an embodiment of a particle manipulation device according to one embodiment of the present invention. Particle manipulation device 60 includes an OET device 61 that functions in the manner described above with reference to FIG. 4 or FIG. 1. An image is projected through the transparent electrode of OET device 61 via an objective lens 62 that images a display 63 onto the photosensitive elements of OET device 61. As will be discussed in more detail below, in this embodiment, display 63 is a micro-mirror array that is illuminated by a light source 65. Display 63 is controlled by a controller 64 which determines which mirrors in display 63 reflect light onto OET device 61.

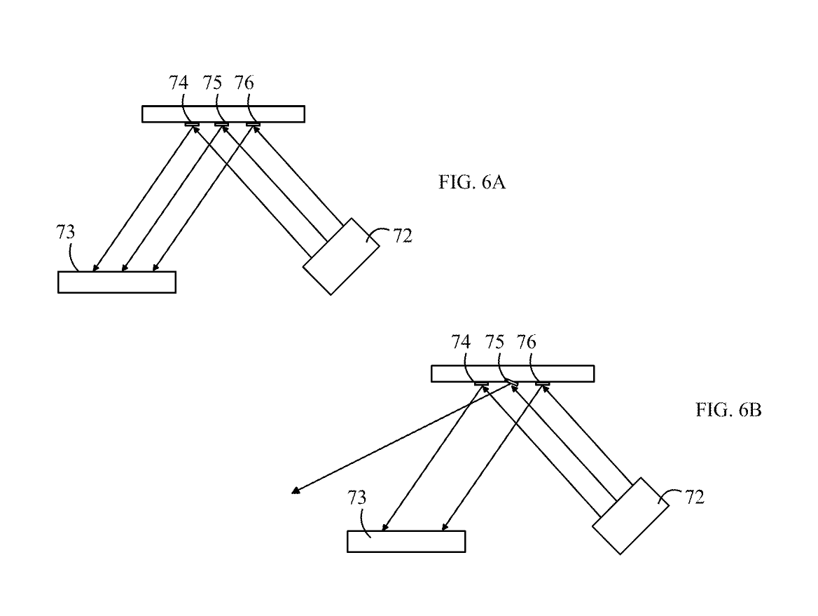

Commercially available digital micro-mirror devices are available from companies such as Texas Instruments. The mirror response times are on the order of 10 microseconds. Refer now to FIGS. 6A and 6B, which illustrate the operation of such a micro-mirror device. The micro-mirror device includes an array of mirrors of which mirrors 74-76 are typical. Each mirror can be independently adjusted such that the mirror reflects light from light source 72 toward OET device 73 or away from OET device 73. Each mirror corresponds to a different pad in OET device 73. In FIG. 6A, mirrors 74-76 are all set to reflect light toward OET device 73, and hence, illuminate the photoconductive elements associated with three corresponding pads in OET device 73. In FIG. 6B, mirror 75 has been set to reflect light away from OET device 73, and hence, the photoconductive element associated with the corresponding pad will not be illuminated.

As the mirrors switch positions, the light from a moving mirror may briefly strike photoconductive elements that are not supposed to be conducting at the time of the mirror switching. This can lead to some noise in the generated electric field in some regions of the channel. Such noise can be avoided by turning off light source 72 briefly during the time that the mirrors are being switched.

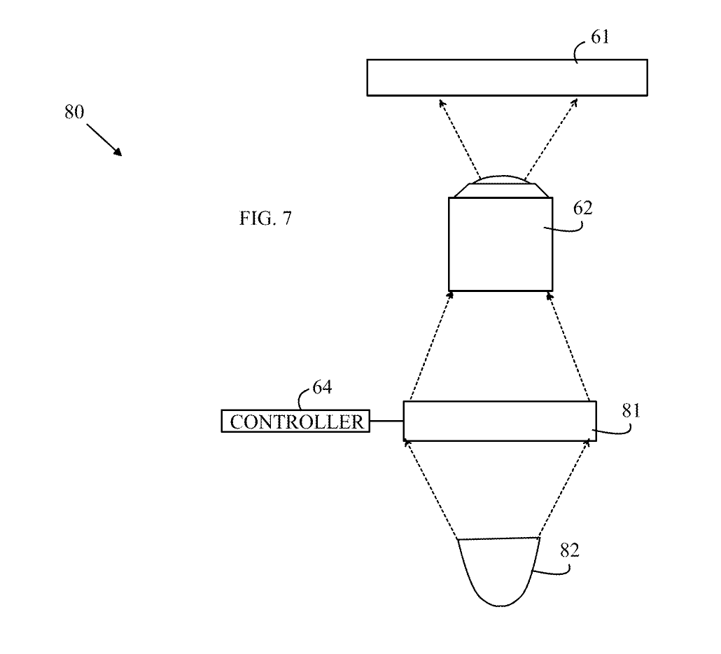

It should be noted that other image generating devices could be used to selectively illuminate the photoconductive elements in the OET devices discussed above. Refer now to FIG. 7, which illustrates a particle manipulation device according to an embodiment of the present invention that utilizes an LCD display. In particle manipulation device 80, the micro-mirror array discussed above has been replaced by an LCD display 81 that is illuminated by light source 82. Alternatively, LCD display 81 could be replaced by an array of LEDs which do not require a separate light source. Organic LEDs are particularly attractive in this regard because of the relatively low cost of displays based on such LEDs.

The above-described embodiments utilize an array of photoconductive elements and an imaging system to generate the desired voltage pattern on one surface of the channel in which the particles move. However, non-optical methods for generating the voltage patterns can also be utilized. One surface of the channel can be viewed as having an array of conductive pads that can be selectively connected to a common electrode by a circuit that has a variable impedance. In the embodiments discussed above, the variable impedance has essentially two states. The first state has an impedance that is small compared to the impedance of the medium in the channel. The second state has an impedance that is large compared to the impedance of the media in the channel. In the above embodiments, the circuits are addressed optically to cause the circuits to switch impedance states.

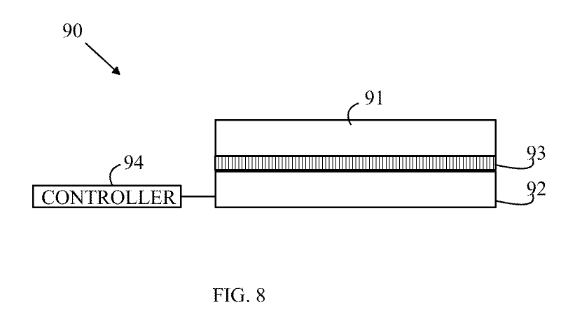

In the embodiments shown in FIG. 7, LCD display 81 is separated from OET device 61 and a lens is used to image LCD display 81 onto OET device 61. However, embodiments in which a display comprising an LCD display or an LED display is in direct contact with OET device 61 can also be constructed. The pixel density of organic LED displays is sufficiently high that such direct particle manipulation devices can be used in some applications. In addition, the pixel density of organic LED displays continually improves. Refer now to FIG. 8, which illustrates a particle motion device according to another embodiment of the present invention in which a direct contact display arrangement is utilized. Particle motion device 90 includes an OET device 91 in which the photoconductive elements are near the surface of the bottom side of the OET device. An LED display 92 is positioned such that each LED illuminates a corresponding one of the photoconductive elements in OET device 91. To prevent cross-talk, a channel plate 93 can optionally be inserted between LED display 92 and OET device 91 to collimate the light from LED display 92. Controller 94 can be part of LED display 92 or a separate controller that updates the controller in LED display 92. This type of embodiment provides two advantages. First, the elimination of the optical system that imaged the display on the OET reduces the cost and complexity of the particle motion device. Second, organic LED displays are mass produced as inexpensive display components, which further reduces the system cost.

However, embodiments that utilize variable impedance elements that are addressed electrically can also be utilized. Arrays of TFT transistors are utilized in many optical displays to control a corresponding array of LEDs or LCD elements. The TFT transistors in the array can be addressed individually and can have a variable impedance that is continuously variable between two limits. Each pad in the channel can be connected to the first electrode via one of these TFT transistors. If used as a switch for switching between two impedance levels as discussed above, the transistors can be turned on and off with the appropriate duty cycle to simulate an intermediate potential across the channel. The circuit element can be viewed as having an average impedance that is the intermediate impedance of the desired value.

However, by utilizing the continuously variable impedance of the transistors, an intermediate voltage can be achieved without the need for switching the transistors back and forth with the corresponding duty factor. Such embodiments also have the advantage of only requiring that a transistor be addressed when the impedance level of that transistor is changed, since the driving circuits can include a storage element that maintains the impedance at the desired level when the transistor is not being addressed. An example of a TFT transistor array that operates an array of organic LEDs can be found in U.S. Pat. No. 6,965,361, which is hereby incorporated by reference. Arrays of variable impedance elements can also be constructed from other types of semiconductor elements including EEPROM memory cells and ferroelectric FETs.

In the above-described embodiments, the potential between the first and second electrodes is an AC potential with an average voltage of zero. As noted above, this ensures that particles that have a net charge are not moved to one or the other of the electrodes. However, in some cases, it can be advantageous to include a non-zero DC component to the potential. First, consider the case in which the particles have no net charge. These particles move in the electric field because of the dipole moment of the particles. The particles are attracted to the region of maximum electric field strength. Since the region of absolute maximum field strength will be at a pad on the edge of the channel, the particles will move in a direction that has both a horizontal and vertical component. Since the direction of the AC field does not alter the point of maximum field strength, the particles will accumulate on the pad. To move the particles horizontally, it is advantageous to move the particles off of the pad prior to applying a potential pattern to a neighboring set of pads. This can be accomplished by interrupting the electric field, i.e., turning the potential “off” on the pad at which the particles have accumulated and allowing Brownian motion to re-suspend the particles. However, this increases the time needed to move the particles of interest from one location to another.

If the particles also have a net charge, a DC component added to the AC field can be used to counteract the vertical motion of the particles that results from the dielectrophoretic attractive forces. The magnitude of the DC component needed to prevent the particles from accumulating on a pad also provides information about the particle. In particular, different types of particles can, in principle, be identified based on this DC component.

The rate at which particles move in the extended electric fields provided by the present invention can also be used to separate different particles based on their speed of motion in the extended electric field. Consider a heterogeneous population of particles having different dielectric constants that have been trapped over one of the pads. If the potential pattern is now altered so that the electric field causes particles to move laterally toward a new maximum field strength position, particles having different dielectric constants will move toward the new maximum field strength location at different velocities. If the electric field generated by the potential pattern has a sufficient lateral extent, the particles will be separated spatially by an amount sufficient to identify different classes of particles before the potential pattern must be moved to keep the particles moving or the particles all finally reach the new position of maximum absolute field strength. The present invention allows such an extended electric field to be generated. Any pattern of electrode effective voltages that yields a monotonically increasing or decreasing electric field strength in the lateral (horizontal) direction would suffice to allow particle separations, as described above, to occur. In one aspect of the invention, the lateral extent of the region of monotonically increasing or decreasing electric field strength is greater than 10 times the diameter of the particles being separated, although much longer lateral extents can be envisioned for separating particles that have very similar dielectric constants.

The above-described embodiments of the present invention have been provided to illustrate various aspects of the invention. However, it is to be understood that different aspects of the present invention that are shown in different specific embodiments can be combined to provide other embodiments of the present invention. In addition, various modifications to the present invention will become apparent from the foregoing description and accompanying drawings. Accordingly, the present invention is to be limited solely by the scope of the following claims.

What is claimed is:

1. An apparatus comprising:
first and second electrodes;
a channel containing a liquid between the first and second electrodes;
an array of variable impedance elements, each variable impedance element connecting said first electrode to a corresponding location in said channel by a path having an average impedance that is continuously variable between first and second impedances when averaged over an update time interval; and
a controller that sets said average impedance of each of said variable impedance elements such that a particle in said channel moves in a predetermined direction when voltage is applied between said first and second electrodes, at least one of said variable impedance elements having an average impedance that is intermediate between said first and second impedances.

2. The apparatus of claim 1 wherein each of said variable impedance elements comprises a switchable photoconductive element having an impedance equal to said first impedance if said switchable photoconductive element is not illuminated with light and an impedance equal to said second impedance if said switchable photoconductive element is illuminated with light, and wherein said apparatus further comprises an optical display that projects an image onto said array of variable impedance elements.

3. The apparatus of claim 2 wherein said switchable photoconductive elements comprise a layer of photoconductive material that connects said channel to said first electrode.

4. The apparatus of claim 2 wherein said switchable photoconductive elements comprise a phototransistor.

5. The apparatus of claim 1 wherein said controller sets said average impedance of a first one of said variable impedance elements to a first value and sets said average impedance of a second one of said variable impedance elements to a second value, said first one of said variable impedance elements being adjacent to said second one of said variable impedance elements and said first value being different from said second value.

6. The apparatus of claim 5 wherein both of said first and second values are intermediate between said first and second impedances.

7. The apparatus of claim 1 wherein one of said variable impedance elements has an impedance equal to said first impedance during a first part of said update time interval and an impedance equal to said second impedance during a second part of said update time interval, said first part and said second part being set to provide said average impedance.

8. The apparatus of claim 1 wherein said controller sets said average impedance of a plurality of said variable impedance elements such that a monotonically increasing or decreasing average electric field strength in a direction parallel to said first electrode is generated in a region containing said particle, each of said plurality of variable impedance elements having a different average impedance.

9. The apparatus of claim 8 wherein said particle is characterized by a diameter and wherein said region has a lateral extent greater than 10 times said diameter.

10. A method for moving particles in a liquid in a channel between first and second electrodes, said method comprising:
providing an array of variable impedance elements, each variable impedance element connecting said first electrode to a corresponding location in said channel by a path having an average impedance that is continuously variable between first and second impedances when averaged over an update time interval; and
setting said average impedance of each of said variable impedance elements such that a particle in said channel moves in a predetermined direction when voltage is applied between said first and second electrodes, at least one of said variable impedance elements having an average impedance over said update time interval that is intermediate between said first and second impedances.

11. The method of claim 10 wherein each of said variable impedance elements comprises a switchable photoconductive element having an impedance equal to said first impedance if said switchable photoconductive element is not illuminated with light and an impedance equal to said second impedance if said switchable photoconductive element is illuminated with light, and wherein said method further comprises projecting an image onto said array of variable impedance elements.

12. The method of claim 11 wherein said switchable photoconductive elements comprise a layer of photoconductive material that connects said channel to said first electrode.

13. The method of claim 11 wherein said switchable photoconductive elements comprise a phototransistor.

14. The method of claim 10 wherein said average impedance of a first one of said variable impedance elements is set to a first value and said average impedance of a second one of said variable impedance elements is set to a second value, said first one of said variable impedance elements being adjacent to said second one of said variable impedance elements and said first value being different from said second value.

15. The method of claim 14 wherein both of said first and second values are intermediate between said first and second impedances.

16. The method of claim 10 wherein one of said variable impedance elements has an impedance equal to said first impedance during a first part of said update time interval and an impedance equal to said second impedance during a second part of said update time interval, said first part and said second part being set to provide said average impedance.

17. The method of claim 10 wherein said average impedance of a plurality of said variable impedance elements is set such that a monotonically increasing or decreasing average electric field strength in a direction parallel to said first electrode is generated in a region containing said particle, each of said plurality of variable impedance elements having a different average impedance.

18. The method of 17 wherein said particle is characterized by a diameter and wherein said region has a lateral extent greater than 10 times said diameter.
